(19) United States
(12) Patent Application Publication
(10) Pub. No.: US 2008/0273243 A1
(43) Pub. Date: Nov. 6, 2008

(54) Device, System and Method of Retro-Modulating Safety Signs

(76) Inventors: Nir Karasikov, Haifa (IL); David Tamir, Haifa (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/916,576

(22) PCT Filed: Jun. 6, 2006
(86) PCT No.: PCT/IL06/00658

§ 371 Date: Dec. 5, 2007

Related U.S. Application Data
(60) Provisional application No. 60/687,348, filed on Jun. 6, 2005.

(51) Int. Cl. G02B 5/124

(52) U.S. Cl. 359/532

(57) ABSTRACT

A traffic safety system may be affiliated with an object to be seen from a distance and may be located within a traffic area. The traffic safety system may comprise a retroreflecting mechanism, enabling to switch between reflecting mode and non retroreflecting mode at certain frequency, thereby creating a flickering effect.

In some embodiments, the retroreflecting mechanism may operated in a retroreflective normally on default mode. The non-reflecting mode may include an absorbing mode, a transmissive mode and/or a dispersive mode.

### FIELD OF INVENTION

This application relates generally to the field of road safety and, more particularly, to retroreflecting materials or setups used for increasing road safety.

### BACKGROUND OF THE INVENTION

A retroreflecting material reflects radiation such as light substantially back to the origin of the radiation, regardless of the radiation's angle of incident onto the retroreflecting material, as known in the art. The radiation source may be, for example, headlights of a motor vehicle.

A traffic safety system may include such a retroreflecting material, whereby the retroreflecting material may be attached to or located nearby any object participating in road traffic such as a pedestrian, an animal, a bicycle driver, or any type of vehicle such as a bicycle, a tractor, a car, a truck and the like. Moreover, the retroreflecting material may be attached to an object or site that may pose a danger to a user of the road. Such a site or object may be, for example, a construction site, a cliff, a curved road, a narrow road, road diversions, a warning triangle and the like. Consequently, if for example, light beams emitted from a motor vehicle's headlight strike the retroreflecting material, those beams may be retroreflected back to the motor vehicle. Therefore, a driver of the motor vehicle may be made aware of an obstacle such as, e.g., pedestrians, bicycle drivers, dangerous road conditions and the like. In consequence, the driver may evade the obstacle. Consequently, a traffic safety system comprising retroreflecting material may increase traffic safety.

Very often, a motor vehicle's high beams must be used as a light source in order to obtain retroreflected radiation that has sufficient intensity to provide the driver of the motor vehicle sufficient warning time of, e.g., an obstacle, another traffic participant, possibly dangerous road conditions and the like. However, using such high beams may also blind another traffic participant.

Other factors that may reduce the retroreflectivity of a material are dust, dirt and the like. Negative effects such as dust, dirt and the like may also be reduced by increasing the retroreflectivity of the retroreflecting material. Environmental factors that may reduce the probability of the driver to pay attention to retroreflectivity are background lights emitted from, e.g., streetlamps. Therefore, visibility of retroreflected light may be reduced to less than 100 m

Retroreflecting materials may comprise, for example, a painted, colored plastic strip whereby the paint may include, e.g., spherical glass particles or an array of corner reflectors, both of which retroreflect the radiation striking thereon. Such retroreflecting materials may be purchased “off the shelf” and are manufactured by, for example, 3M Innovative Properties Company. Retroreflecting material that measures approximately 5×40-50 cm may render, under ideal visibility, i.e., no rain, no fog and the like, a detection of retroreflected radiation possible to a distance of up to approximately 100 meters.

Furthermore, retroreflecting materials may be implemented as described by Minoura et al., U.S. Pat. No. 6,657,766, “Reflective display device and retro-reflector used therefore” or as described by Popovich et al., U.S. Pat. No. 6,353,489, both of which are incorporated by reference for all purposes as if fully set forth herein.

Other prior art systems, apparatuses and methods for increasing traffic safety include light emitting diodes (LEDs). Such an LED-based system typically includes a piezoelectric device coupled to an LED. Changing the shape of the piezoelectric device by, for example, applying pressure, typically generates a charge, which is converted to voltage or electrical current, which triggers the LED to emit light. Such an LED-based traffic safety system may be integrated, for example, into apparel such as, e.g., the sole of a shoe. A person treading with such a shoe on the ground triggers the LED to emit light, giving indication of the presence of said pedestrian. A striking disadvantage of LED-based safety systems is the relatively low radiation intensity of the light emitted from the LED, caused by the limited energy that can be supplied to such an LED, due to physical limitations of the LED. The light of an LED can typically be seen from a distance of only a few meters. Therefore, it may be desirable to enhance the intensity of illumination based traffic safety systems without the need to use high-power sources.

### BRIEF DESCRIPTION OF THE DRAWINGS

The subject matter regarded as the invention will become more clearly understood in light of the ensuing description of embodiments thereof given by way of example only, with reference to the accompanying drawings,

FIG. 1 is a schematic illustration of a traffic safety system according to a demonstrative embodiment of the invention;

FIG. 2 is a schematic illustration of a traffic safety system comprising a sensor system according to another demonstrative embodiment of the invention;

FIG. 3 is a schematic block diagram of a sensor system according to the demonstrative embodiment of the invention of FIG. 2;

FIG. 4 is a schematic illustration of a retroreflector having a voltage grid according to a demonstrative embodiment of the invention;

FIG. 5a is a schematic illustration of a retroreflector in a retroreflective mode according to a demonstrative embodiment of the invention;

FIG. 5b is a schematic illustration of the retroreflector in a non-retroreflecting mode according to the demonstrative embodiment of FIG. 5a;

FIG. 5c is a schematic illustration of a retroreflector in a dispersive mode according to a further demonstrative embodiment of the invention;

FIG. 6a is a schematic illustration of a retroreflector in retroreflective mode, according an additional demonstrative embodiment of the invention;

FIG. 6b is a schematic illustration of the retroreflector in non-retroreflecting mode according to the additional demonstrative embodiment of FIG. 6a;

FIG. 7a is a schematic illustration of a retroreflector in retroreflecting mode according to yet another demonstrative embodiment of the invention;

FIG. 7b is a schematic illustration of the retroreflector in a non-retroreflecting mode according to the demonstrative embodiment of FIG. 7a;

FIG. 8 is a schematic illustration of a retroreflector according to another alternative demonstrative embodiment of the invention;

FIG. 9 is a schematic illustration of a retroreflector according to a further alternative demonstrative embodiment of the invention;

FIG. 10a is a schematic illustration of a retroreflector in a retroreflecting mode according to yet an additional demonstrative embodiment of the invention; and

FIG. 10b is a schematic illustration of the retroreflector in a non-retroreflecting mode according to the yet additional demonstrative embodiment of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF SOME DEMONSTRATIVE EMBODIMENTS OF THE INVENTION

According to some demonstrative embodiments of the invention, a traffic safety system may be affiliated with an object to be seen from a distance and may be located within a traffic area.

In some embodiments, the traffic safety system may comprise a retroreflecting mechanism, enabling to switch between reflecting mode and non retroreflecting mode at certain frequency, thereby creating a flickering effect.

In some embodiments, the retroreflecting mechanism may operated in a retroreflective normally on default mode. The non-reflecting mode may include an absorbing mode, a transmissive mode and/or a dispersive mode.

In some embodiments, the switching operation may be accomplished by applying to the retroreflector a voltage above a certain threshold.

In some embodiments, the switching operation may be accomplished by modulating at a predetermined frequency the voltage applied to the retroreflector.

In some embodiments, the switching operation may be accomplished through means of mechanical modulation at a predetermined frequency, resulting in a flickering frequency that may correspond to the modulation frequency.

In some embodiments, the flickering frequency may substantially corresponds to a human's eye maximal flicker sensitivity.

In some embodiments, the object may comprise at least one of the following groups: apparel, an obstacle, a road condition and a traffic participant.

In some embodiments of the invention, the retroreflector may comprise a polymer having physical characteristics that are set into effect depending on a voltage applied to the retroreflector.

In some embodiments, the polymer is located between two substantially transparent conducting plates, whilst the voltage is applied to the conducting plates.

In some embodiments, the retroreflector may substantially rigid. In other embodiments the retroreflector may be flexible.

In some embodiments, the electrical drive may be powered by at least one of the following means: disposable batteries, rechargeable batteries, solar cells, paper batteries or Piezo-charge generators and dynamo generators.

In some embodiments, the electrical drive may be energized by radiation striking the retroreflecting system.

In some embodiments, the retroreflector may comprise a voltage grid configuration.

In some embodiments, the retroreflector may comprise a voltage grid configuration composed by standard retroreflector and modulatable retroreflector.

In some embodiments, the traffic safety system may comprise a sensor that may activate the electrical drive only when the intensity of the daylight is below a certain threshold.

In some embodiments, the traffic safety system may further comprise a sensor system able to detect retroreflected radiation.

In some embodiments, the sensor system may comprise a warning apparatus to emit a warning signal.

In some embodiments, the sensor system may comprise a lock-in amplifier. In some embodiments, the sensor system may comprise a modulator.

In some embodiments, the sensor system may comprise at least one of the following radiation sources: an IR radiation source or a Gunn diode.

In some embodiments, the sensor system may emit a warning signal upon detecting radiation that is retroreflected due to radiation having intensity above a predetermined threshold.

In some embodiments, the sensor system may comprise an amplifier operating at a synchronized frequency.

In some embodiments, a method is provided that may cause an observer of retroreflected radiation to pay closer attention to traffic conditions, by modulating voltage and applying the voltage on retroreflector operating in a normally-on condition.

### DETAILED DESCRIPTION OF DEMONSTRATIVE EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known devices, methods, procedures and/or components have not been described in detail so as not to obscure the invention.

It is the purpose of the present invention to cause an observer of retroreflected radiation to pay closer attention to traffic conditions. This may accomplished, for example, by implementing a traffic safety system that generates flickering radiation.

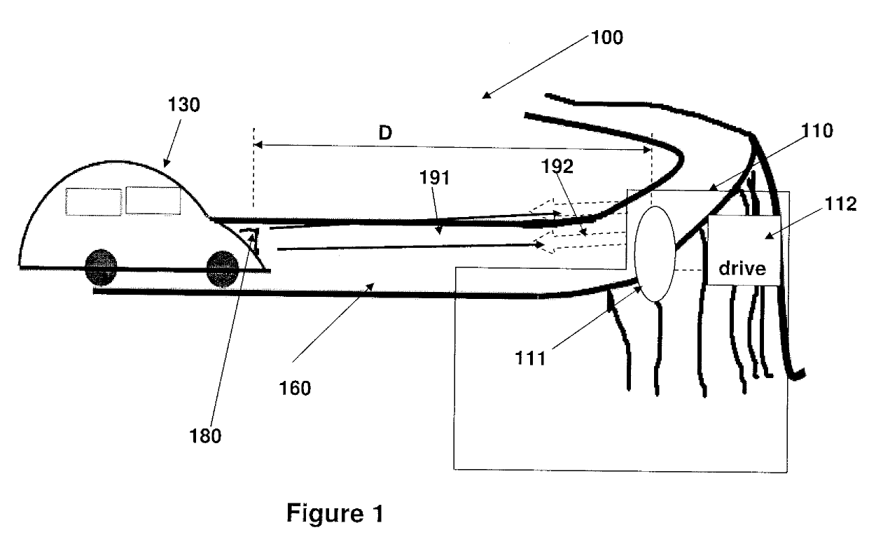

Reference is made to FIG. 1, which schematically illustrates a traffic safety system 100, according to a demonstrative embodiment of the invention, comprising a retroreflecting mechanism 110. Retroreflecting mechanism 110 may include a retroreflecting setup and/or material 111, hereinafter referred to as “retroreflector”, and an electrical drive 112.

According to a demonstrative embodiment of the invention, retroreflector system 110 may be set up at a location where an indication of road conditions, obstacles and the like, may be necessary.

Retroreflecting mechanism 110 may be adapted to have two operational modes: a retroreflective mode and a non-retroreflecting mode, both of which may be determined according to the operation of electrical drive 112 or to a heating/cooling device, as will be outlined in detail below.

It may be noted that the non-reflective node refers to a situation where radiation striking retreflector 111 is substantially absorbed, transmitted and/or dispersed.

Radiation striking retroreflector 111 may be retroreflected. Consequently, a person who is in the path of the retroreflected radiation, may be made aware of other traffic participants, road conditions indicators, obstacles, warning signs and the like. A traffic participant may be, for example, a driver of a motor vehicle, a bicycle rider and the like. A dangerous road condition may be, for example, a sharp curve, a cliff, a steep road and the like. A warning sign may be, for example, a warning triangle and the like.

In order to operate retroreflector system 110 in the non-retroreflecting mode, electrical drive 112 may apply a voltage above a certain threshold Vₜₕᵣₑₛₕ to retroreflector 111. The threshold Vₜₕᵣₑₛₕ may be, for example, a very low voltage of 10 Volts, 20 Volts and/or a voltage of approximately 50 Volts and higher. Conversely, in order to operate retroreflector system 110 in the retroreflective mode, the applied voltage ought not to exceed the threshold Vₜₕᵣₑₛₕ. Consequently, retroreflector system 110 may be in the retroreflecting mode if, for example, no voltage is applied. For example, radiation striking retroreflector 111 may be retroreflected when no voltage is applied to retroreflector 111. Conversely, when applying a voltage above or equal Vₜₕᵣₑₛₕ to retroreflector 111, radiation striking retroreflector 111 may be substantially transmitted, dispersed and/or absorbed. Retroreflecting mechanism having such operational characteristics may be defined as operating in a “Normally On” condition.

By applying voltage above or equal threshold Vₜₕᵣₑₛₕ to retroreflector 111, optical retroreflecting elements such as, e.g., corner reflectors, disposed on retroreflector 111 may be deformed, thereby causing radiation striking the optical retroreflecting elements to be absorbed, transmitted and/or dispersed. In consequence, applying voltage above or equal threshold Vₜₕᵣₑₛₕ causes retroreflector system 110 to switch from retroreflecting to non-retroreflecting mode.

In some demonstrative embodiments of the invention, switching periodically between the retroreflecting and the non-retroreflecting mode may be accomplished by applying a modulation scheme. Accordingly, the frequency of switching between the retroreflecting and the non-retroreflecting mode may correspond to the frequency of the modulation scheme. A possible modulation scheme may be, for example, On-and-Off-Keying (OOK).

It may be noted that other modulation schemes or techniques may be used. For example, a MEMS device, a chopper and the like may be used as switches enabling modulating retroreflector 111.

In some demonstrative embodiments of the invention, a distance D of a motor vehicle's headlight and the modulation frequency may be set to result in a flickering frequency that substantially corresponds to the human eye's maximal sensitivity to e.g., flickering of light. Such a flickering frequency may range between, e.g., 5 to 25 Hz. For example, a maximal sensitivity to the flickering of light, and thus a maximal awareness to an obstacle, other traffic participants and the like, may be reached when a motor vehicle's headlights are located at a distance D of e.g., 60 meters in front of retroreflector 110 having a retroreflection area of, e.g., 5 cm×40 cm. As a result, a modulation frequency may be set between, e.g., 5 and 25 flickers per seconds. A person may react to flickering after, e.g., six cycles of flickering radiation. The flickering frequency may be, e.g., six flickers per seconds. Thus, the observer may react to the perceived radiation after approximately one second and may therefore try to avoid a possible obstacle on road 160. Using retroreflected radiation having a flickering frequency substantially corresponding to the human eye's maximum flickering sensitivity may significantly reduce reaction time of the observing person, compared to a person's reaction time when using non-flickering retroreflected radiation.

In some demonstrative embodiments of the invention, retroreflector system 110 may also be integrated or attached to apparel such as, for example, shoes, a belt, trousers and the like. Furthermore, retroreflector system 110 may be integrated into a vehicle such as a bicycle, thereby indicating the position of the vehicle if radiation is striking retroreflector 111.

In some demonstrative embodiments of the invention, retroreflector 111 may be implemented using polymers that may change their physical characteristics depending on the voltage applied to the polymer. Such a polymer may be of a type of, for example, Polymer Dispersed Liquid Crystal (PDLC). PDLC polymers, which may be disposed between two substantially transparent conducting plates, coatings or both, may be transformed from a reflective state to a non-retroreflecting mode by applying an electrical field between the transparent conducting plates or coatings. Prior art implementation of PDLC strips is typically implemented as window shade covers. By applying a changing voltage, which may vary between 50-112 volts, to the PDLC strips, the transmittance of the PDLC strips may vary.

In one demonstrative embodiment of the invention, retroreflector 11l may be substantially rigid. According to another demonstrative embodiment of the invention, retroreflector 111 may be flexible. Using a flexible material for retroreflector 111 may facilitate attaching retroreflector 111 to, e.g., road bumpers, curved guardrails and the like, vehicles such as, e.g., an automotive, a bicycle; and apparel such as shoes, a belt and the like.

Various power sources may supply power to electrical drive 112. Such a power source may be, but is not limited to, for example, disposable batteries, rechargeable batteries, solar cells, paper batteries, Piezo-charge generators and the like. Moreover, electrical drive 112 may receive electrical power from a motor vehicle battery, the dynamo of, e.g., a bicycle and the like. According to some demonstrative embodiments of the invention, the radiation striking retroreflector 111 may be used to energize electrical drive 112. For example, light originating from a motor vehicle's headlight may energize electrical drive 112. Furthermore, electrical drive 112 may receive electrical power from an energy source, e.g. a 1.5 volt battery, via a generator, which may result in a voltage of approximately 60 volt at electrical drive 112.

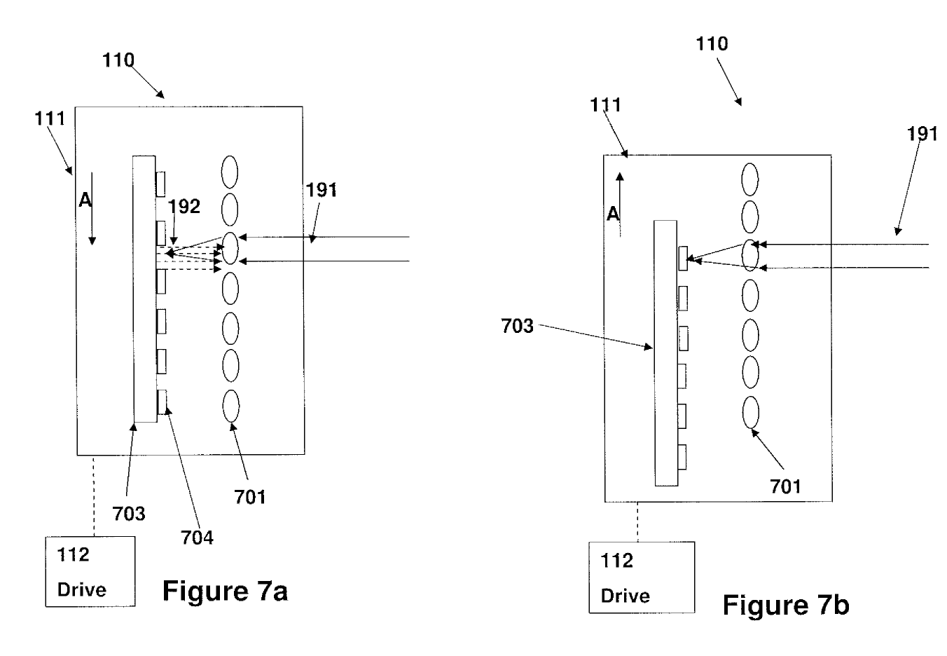

According to a demonstrative embodiment of the invention, retroreflector system 110 may change from a retroreflective to a non-retroreflecting by applying a mechanical force on components of retroreflector 111, as will be outlined below with reference to FIGS. 7a, 7b, 8, 9, 10a and 10b.

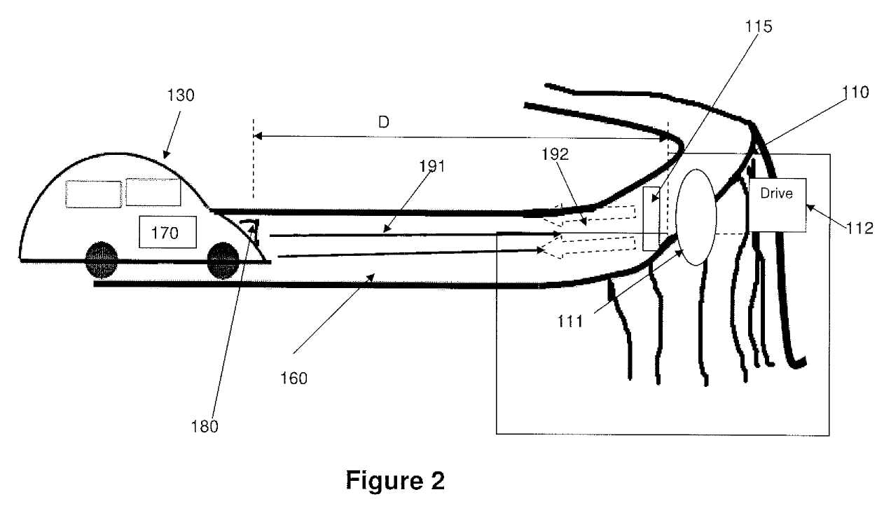

Reference is now made to FIG. 2, which schematically illustrates a traffic safety system comprising a sensor system.

According to some demonstrative embodiments of the invention, traffic safety system 100 may include a sensor system 170. Sensor system 170 may be adapted to trigger a warning signal, such as an audible signal, after detection of, for example, six cycles of flickered radiation being in, e.g., the infrared spectrum, which is beyond the human eye visible range and at a flicker frequency which renders a shorter response time than the human eye. Therefore, if a flickering frequency is, e.g., 100 Hz, sensor system 170 may trigger a warning signal after 0.06 seconds. Accordingly, an even shorter reaction time compared to the modulation of the eye flickering sensitivity range of, e.g., 5-25 Hz may be obtained. It may be noted that atmospheric transmittance of radiation in, e.g., the infrared spectrum, the microwave spectrum and the like may be higher compared to radiation in the visible spectrum. Therefore, distance D between retroreflector system 110, which may be attached to or located near e.g., a possible obstacle, traffic participant and the like, and e.g., sensor system 170 detecting retroreflected radiation, may be extended. It may be further noted that sensor system 170 may be adapted to all types of vehicles and other traffic participants such as pedestrians.

According to another demonstrative embodiment of the invention, sensor system 170 may be adapted to trigger a warning after detecting a predetermined number of flickering radiations in e.g., the microwave range.

Filter 115 may comprise of e.g., Nano-particles, quantum dots or both, adapted to selectively filter, transmit or both specific spectral bands, e.g., as known in the art. Such filters may be purchased “off the shelf” and are manufactured by, e.g., Kodak and JDS uniphase.

According to other demonstrative embodiments of the invention, sensor system 170 may be adapted to detect radiation having wavelengths that are spread over a band of spectra or may be adapted to detect radiation at substantially one wavelength.

Sensor system 170 may be installed in various locations including, for example, in a vehicle, a pedestrian's clothing and the like.

According to some demonstrative embodiments of the invention, radiation striking retroreflector 111 may trigger retroreflection when the striking radiation has an intensity approximately corresponding to, e.g., a motor vehicle's high beams. Consequently, a driver of a motor vehicle may be made aware of the fact that the high beams are on, alerting the driver to switch from high beams to regular headlights to avoid blinding an oncoming driver.

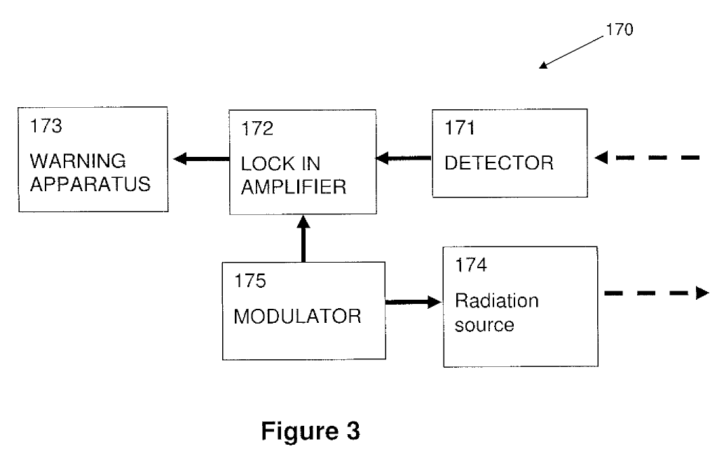

Reference is now made to FIG. 3, which schematically illustrates a block diagram of a sensor system, according, to a demonstrative embodiment of the invention.

Sensor system 170 may include a photo-detector 171, a lock-in amplifier 172 and a warning apparatus 173. Retroreflected radiation may be detected by, e.g., photo-detector 171. A signal representing retroreflected radiation may be extracted by, e.g., lock-in amplifier 172, which may operate at a synchronizing frequency range F of, e.g. 100-1000 Hz and at an integrating bandwidth B of, e.g., 1 Hz.

According to another demonstrative embodiment of the invention, sensor system 170 may further include a radiation source 174 such as, for example, an infrared or Gunn diode, and a modulator 175.

In addition to the radiation emitted by e.g., headlights of a car, radiation source 174 may emit radiation having spectra being in, e.g., the infrared spectrum, the microwave spectrum and the like. Radiation being in, e.g., the infrared and/or microwave spectrum may have enhanced transmittance compared to radiation being in, e.g., the visible spectrum. Therefore, radiation being in, e.g., the infrared and/or microwave spectrum, may strike at a higher intensity on retroreflector 111, compared to radiation being in, e.g., the visible spectrum. In consequence, retroreflected radiation being in, e.g., the infrared and/or microwave spectrum may have a hi-her intensity compared to retroreflected radiation being in, e.g., the visible spectrum. This feature may be significant when the atmosphere is, e.g., foggy, during rainfall and the like.

Radiation source 174 may be, for example, a single 1-watt diode operating at a frequency of 100 Hz. Thus configured, sensor system 170 may be able to provide an advanced warning time of, e.g., one second.

According to another embodiment of the invention, modulator 175 may modulate radiation, which may be in the infrared, the microwave spectrum or both, emitted by, e.g., headlights of a vehicle or a radiation source 174. Therefore, even though retroreflector 110 is not modulated, the retroreflected radiation may still be perceived as flickering, detected or both, and a warning signal may be triggered thereof.

Upon detection of the retroreflected radiation, warning apparatus 173 may provide the driver of a vehicle with a warning signal such as, for example, an audible alarm.

For example, warning apparatus 173, which may be installed in a vehicle such as, for example, a motor vehicle 130, may sound an audible alarm based on, e.g., retroreflected radiation that may be in, e.g., the infrared spectrum, while, e.g., driver of motor vehicle 130 may perceive the radiation that is in the visual spectrum. It may be noted that sensor system 170 may be attached to, e.g., pedestrians, bicycles, a warning triangle, an obstacle and the like.

According to some demonstrative embodiments of the invention, traffic safety system 1000 may be adapted to withstand environmental conditions such as, for example, high temperatures, e.g., 35° C., 65° C., low temperatures, e.g., −20° C., −40° C., high relative humidity of, e.g., 80%, rain, snow, solar UV radiation and the like.

According to some demonstrative embodiments of the invention, traffic safety system 100 may include means to avoid wasting electrical power. Such provisions may include, for example, a sensor that may trigger turning on electrical drive 112, only when the intensity of the daylight is below a certain threshold. Therefore, the sensor may ensure that electrical drive 112 is energized only when flickering retroreflection is necessary, thereby saving electrical power. Other means may include a sensor that may activate electrical drive 112 only when radiation such as, e.g., light is striking retroreflector 111.

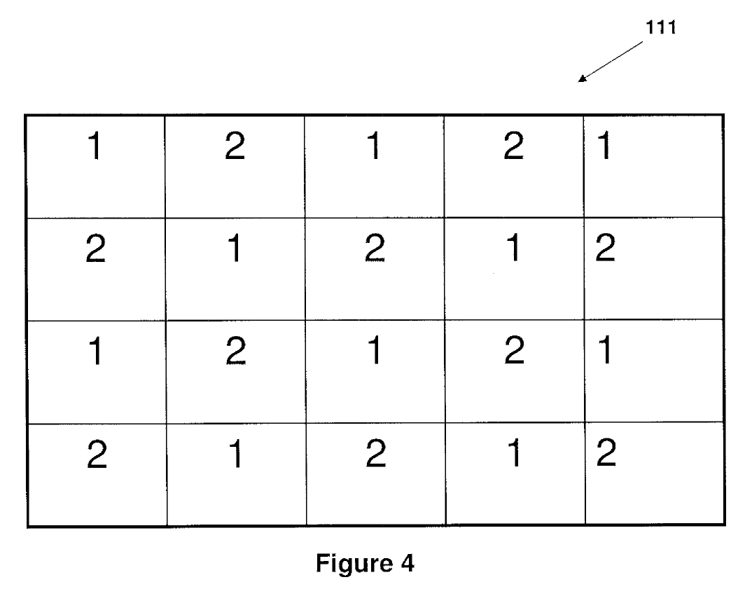

Reference is now made to FIG. 4, which schematically illustrates a retroreflector having a voltage grid configuration.

According to another demonstrative embodiment of the invention, retroreflector 111 may comprise a voltage grid having a plurality of sections. Two consecutive sections of the grid may be denoted as ‘1’ and ‘2’. A voltage may be applied alternately to sections ‘1’ and ‘2’. Accordingly, if voltage equal or above a required non-retroreflection threshold v Vₜₕᵣₑₛₕ is applied to section ‘1’ and substantially no voltage (V1≈0) is applied to section ‘2’, radiation striking retroreflector 111 may be retroreflected by section ‘2’. By subsequently applying voltage equal or above V2 to section ‘2’ while substantially not applying voltage to section ‘1’, radiation striking retroreflector 110 may be retroreflected by section ‘1’. Other grid configurations and/or sequences of applying a voltage and/or current may be used.

According to some other demonstrative embodiments of the invention, the section denoted as ‘1’ may comprise standard retroreflecting material, whereas the section denoted as ‘2’ may comprise of retroreflecting material that may be modulated.

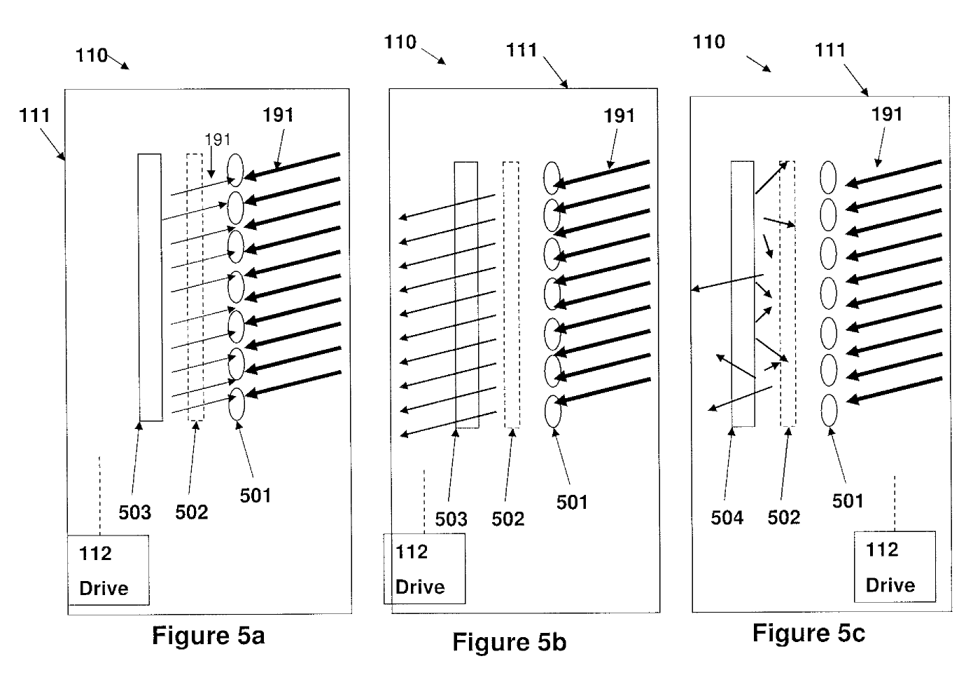

Reference is now made to FIG. 5a, which schematically illustrates a retroreflector system in a retroreflective mode, according to a demonstrative embodiment of the invention, and to FIG. 5b, which schematically illustrates the retroreflector system in non-retroreflecting mode, according to the demonstrative embodiment of FIG. 5a.

According to a demonstrative embodiment of the invention, retroreflector III may include a lenslet array 501, a liquid crystal modulator 502 and a reflector 503. As schematically indicated at FIG. 5a, radiation 191 striking retroreflector 111, which is not being under voltage, may be substantially retroreflected. Thus, retroreflected radiation 192 is obtained. In some embodiments, lenslet array 501 may be omitted.

Voltage Vₜₕᵣₑₛₕ may be a voltage required for switching retroreflector system 110 from the retroreflective to the non-retroreflective mode. Therefore applying a voltage V2 that is equal or above Vₜₕᵣₑₛₕ, may cause retroreflector system 1101 to switch from the retroreflective to the non-retroreflecting mode. Accordingly, radiation 191 striking retroreflector 111 may be substantially transmitted.

Reference is now made to FIG. 5c, which schematically illustrates a retroreflector system in a dispersive mode, according to a further demonstrative embodiment of the present invention.

Vₜₕᵣₑₛₕ may be the voltage required for switching retroreflector system 110 from the retroreflective to the non-retroreflecting mode. Accordingly, when applying on retroreflector 111 a voltage V2 that is equal or above Vₜₕᵣₑₛₕ, radiation 191 may be dispersed.

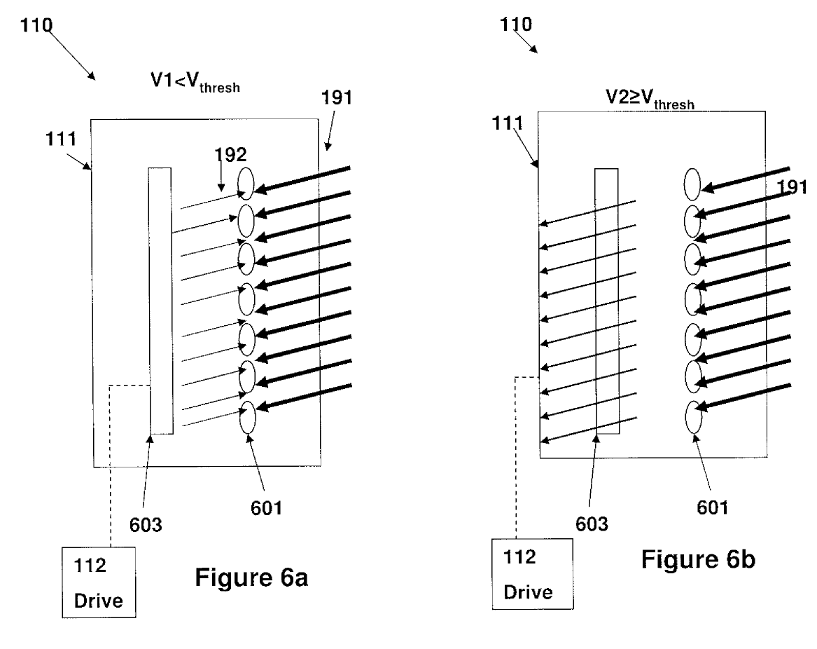

Reference is now made to FIG. 6a, which schematically illustrates a retroreflector system in retroreflective mode according to an additional demonstrative embodiment of the invention; and to FIG. 6b, which schematically illustrates a retroreflector system in retroreflecting mode according to the additional demonstrative embodiment of FIG. 6a.

Retroreflector system may include a lenslet array 601 and a modulator 603, which may be made of e.g., PDLC. When voltage below required threshold Vₜₕᵣₑₛₕ is applied on modulator 603, radiation 191 propagating through lenslet array 601 strikes modulator 603. In consequence, radiation 191 is diffused and retroreflected. The amount of backscattered radiation 192 may attain a level of approximately 50%. Conversely, when voltage above Vₜₕᵣₑₛₕ is applied, modulator 603 becomes substantially transparent and radiation 191 is not retroreflected.

Reference is now made to FIG. 7a, which schematically illustrates a retroreflector system in retroreflecting mode according to yet another demonstrative embodiment of the invention, and to FIG. 7b, which schematically illustrates the retroreflector system in non-retroreflecting mode according to the yet other demonstrative embodiment shown in FIG. 7a.

According to yet another demonstrative embodiment of the invention, retroreflector system 110 may be implemented mechanically, as described in detail below. For example, retroreflector 111 may include an absorbing substrate 703 having disposed thereon a plurality of optical retroreflecting elements 704. Retroreflector 111 may further include a lenslet array 701, which may be moved relative to absorbing substrate 703.

In the retroreflecting anode, lenslet array 701 may be positioned in a manner such that substantially all of radiation 191 passing through lenslet array 701 strikes retroreflecting optical elements 704, i.e., optical elements 704 lie in the focal plane of lenslet array 701. In consequence, radiation 191 may be retroreflected as radiation 192.

In the non-retroreflecting mode, lenslet array 701 may be positioned in a manner such that substantially all of the radiation passing through lenslet array 701 strikes absorbing substrate 703. In consequence, substantially all of radiation 191 passing through lenslet array 701 may be absorbed.

Optical elements 704 may be disposed on absorbing substrate 703 in a Ronchi ruling pattern, e.g., as known in the art, which can be produced, for example, by lithographic processes.

Lenslet array 701 may have dimensions of, e.g., 1×1 mm and a focal length of e.g., 5 mm. The width of retroreflecting optical elements may be, for example, 1 mm. In consequence, the angular field of view of retroreflector is 1 mm/5 mm≈0.25rad 14 degrees. As a result, retroreflected radiation may be sensed, observed or both, from for example, any point on a 20 meters wide road from a distance of 100 meters.

Energy consumption for retroreflecting mechanism 110 according to the yet other embodiment of the invention may be as outlined below.

For example, substrate 703 may be made of, e.g., polycarbonate having a density of approximately 2 grams/cm³. When having a surface of 10×50 cm² and thickness of 1 mm, the volume of substrate is 10 cm×50 cm×0.1 cm=50 cm³. The mass M of the grating is therefore approximately 100 grams. The average velocity V of substrate 703 may be 1 mm/0.1 sec=1 cm/sec=0.01 meter/sec. Assuming a stepping motor is moving the grid from one position to the second one, and repeats that step 10 times/sec, the energy necessary to move the grid each cycle is the kinetic energy of the grid, namely E˜MV**2=0.0001 Joules/cycle. The power level W is W=E/T=0.0001/0.1=0.001 watts. At such a low power level, retroreflecting mechanism 110 may be operated for days with a car battery, or days by a solar cell, which charges a battery during a short period of time such as one hour.

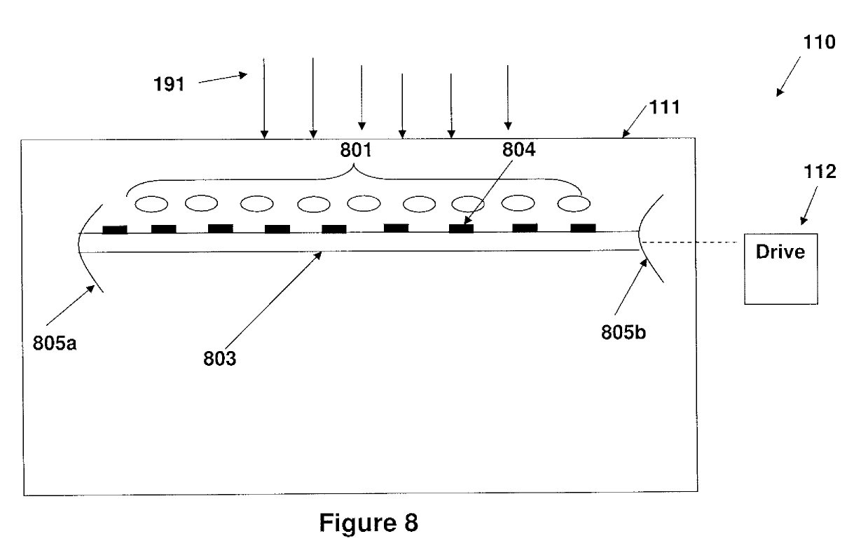

According to another alternative embodiment of the invention schematically illustrates in FIG. 8, a retroreflector system 110 may include electrical drive 112 adapted to bring flexible membranes 805a and 805b of retroreflector 111 into vibration at a predetermined frequency. A substrate 803 may be confined between and attached to flexible membranes 805a and 805b. Furthermore, retroreflecting optical elements 804 may be substantially evenly disposed on substrate 803. Retroreflector III may also include a lenslet array 801.

In the retroreflecting mode, lenslet array 801 may be positioned relative to optical elements 804 in a manner such that substantially all of radiation 191 passing through lenslet array 801 strikes optical elements 804. In consequence, radiation 191 may be retroreflected.

In the non-retroreflecting mode, motor 810 may be operated, thereby resulting in vibration of flexible membranes 805a and 805b. In consequence, optical elements 804 may be deformed, causing radiation 191 striking said elements 804 to be absorbed, dispersed or both.

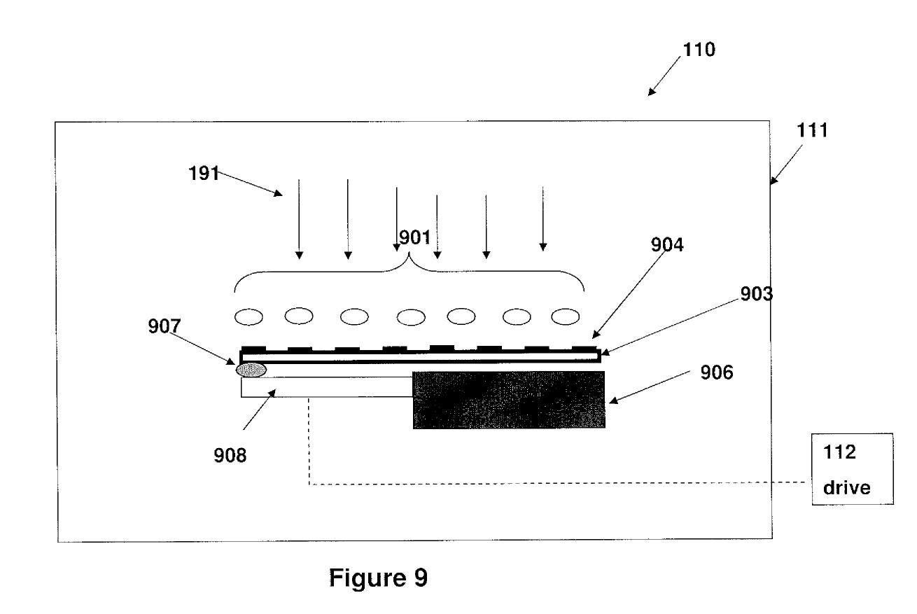

Reference is now made to FIG. 9, which schematically illustrates a retroreflector system according to a further alternative demonstrative embodiment of the invention.

According to a further alternative demonstrative embodiment of the invention, retroreflector system 110 may include retroreflector 111, which may comprise a vibrating grid 903 having disposed thereon retroreflecting optical elements 904, such as, e.g., corner reflectors, etc. Vibrating grid 903, which may be substantially transmissive, substantially absorbing as well as dispersing, e.g., optical radiation, may be attached via a bond 907 to a piezoelectric element 908. Piezoelectric material 908 may be bonded to fixture 906.

When no voltage is applied to piezoelectric element 908, vibration grid 903 may be adjusted relative to a lenslet array 901 in a manner, such that substantially all radiation 191 passing through said lenslet array 901 strikes retroreflecting optical elements 904. Therefore, radiation 191 may be retroreflected. Conversely, applying voltage above a required threshold to piezoelectric material 908 may cause piezoelectric element 908 to change its shape in a manner such that radiation 191 may strike vibration grid 903. Therefore, radiation 191 may be substantially transmitted, substantially dispersed or both. Accordingly, there may be no retroreflection of radiation 191.

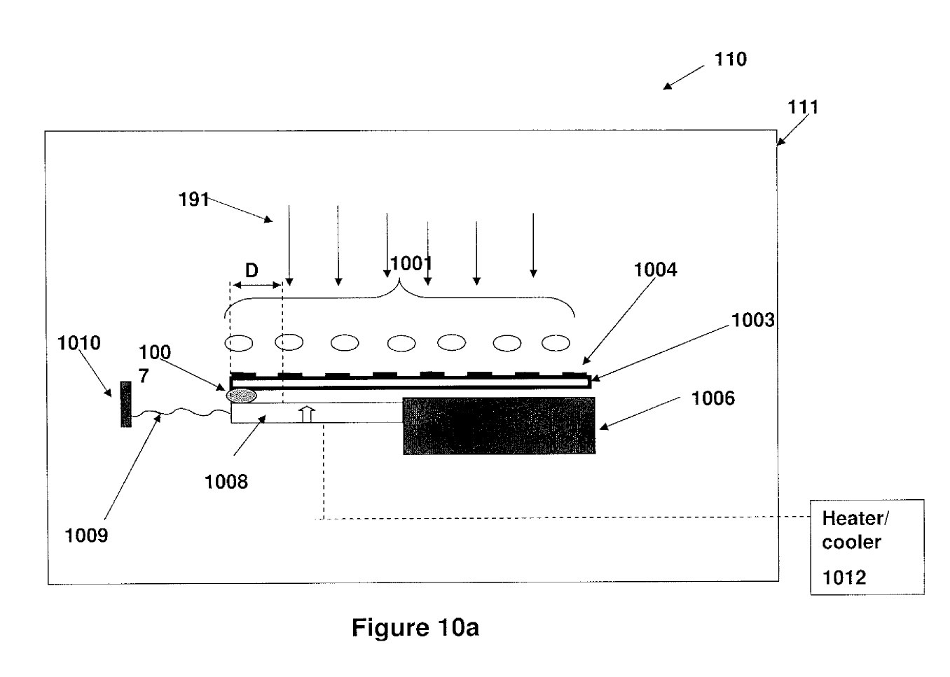

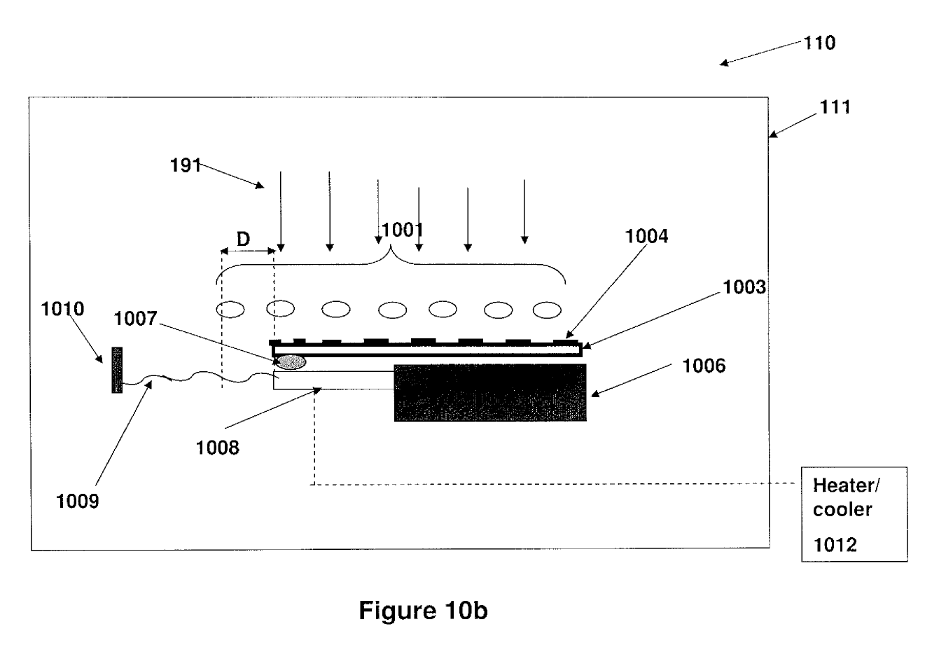

Reference is now made to FIG. 10a, which schematically illustrates a retroreflector system in retroreflecting mode according to yet an additional demonstrative embodiment of the invention and reference is made to FIG. 10b, which schematically illustrates the retroreflector system in non-retroreflecting mode according to the yet additional demonstrative embodiment of FIG. 10a.

According to a further alternative demonstrative embodiment of the invention, retroreflector system 110 includes retroreflector 111, which may comprise an absorbing or transmissive vibrating grid 1003 having disposed thereon islands of retroreflecting optical elements 1004, such as, e.g., corner reflectors. Vibration grid 1003 may be substantially absorbing, transmissive and/or dispersing to, e.g., optical radiation. Vibrating grid 1003 may be attached via a bond 1007 to a shape memory alloy (SMA) 1008, which may be bonded to a fixture 1006. A lenslet array 1001 may be located in front of vibrating grid 1003. A spring 1009 may be bonded to SMA 1008 and to a static fixture 1010. Spring 1009 may be implemented, e.g., as a metallic membrane, a cylinder filled with pressurized air and the like, e.g., as known in the art.

In an initial state, SMA 1008 at temperature T1 may have a higher elasticity than spring 1009. In consequence, spring 1009 may exert a force on SMA 1008 causing vibration grid 1003 to be positioned relative to lenslet array 1001 in a manner such that radiation 191 passing through lenslet array 1001 may strike retroreflecting optical elements 1004. By applying, e.g., a temperature T2 through a heater/cooler 1012, whereas T2≠T1, to SMA 1008, e.g., as is known in the art, SMA 1008 may, e.g., apply a force F to spring 1009 that may overpower spring constant K of spring 1009. Therefore, SMA 1008 may change its shape, as schematically indicated with arrow D, and as schematically depicted at FIG. 10b. Due to the changing of shape of SMA 1008, retroreflector system 110 may be set into the non-retroreflective mode, wherein radiation 191 passing through lenslet array 1001 may strike vibration grid 1003.

Subsequent application of temperature T1 through heater/cooler 1012 on SMA 1008 may cause SMA 1008 to become loose, causing spring 1009 to overpower elasticity of SMA 1008. Therefore, SMA 1008 may return to its shape of the initial state. In consequence, retroreflector system 110 may be reset to the retroreflecting mode.

While the invention has been described with respect to a limited number of embodiments, these should not be construed as limitations on the scope of the invention, but rather as exemplifications of some of the embodiments. Those skilled in the art will envision other possible variations, modifications, and applications that are within the scope of the invention. Accordingly, the scope of the invention should not be limited by what has thus far been described, but by the appended claims and their legal equivalents.

What is claimed is:

1. A traffic safety system affiliated with an object to be seen from a distance and located within a traffic area, said safety system comprising:
a retroreflecting mechanism, enabling to switch between reflecting mode and non retroreflecting mode at certain frequency, thereby creating flickering effect.

2. The traffic safety system of claim 1 wherein the retroreflecting mechanism is operated in a retroreflective normally on default mode.

3. The traffic safety system of claim 1 wherein the non retroreflecting mode include absorbing mode.

4. The traffic safety system of claim 1 wherein the non retroreflecting mode include transmissive and dispersive mode.

5. The traffic safety system of claim 1 wherein said switching operation is accomplished by applying to said retroreflector a voltage above a certain threshold.

6. The traffic safety system of claim 1 wherein said switching operation is accomplished by modulating at a predetermined frequency the voltage applied to said retroreflector.

7. The traffic safety system of claim 1 wherein said switching operation is accomplished through means of mechanical modulation at a predetermined frequency.

8. The traffic safety system of claim 1 wherein said frequency results in a flickering frequency corresponding to said modulation frequency.

9. The traffic safety system of claim 8, wherein said flickering frequency substantially corresponds to a human's eye maximal flicker sensitivity.

10. The traffic safety system of claim 1 wherein said object comprises at least one of the following groups: apparel, an obstacle, a road condition and a traffic participant.

11. The traffic safety system of claim 1, wherein said retroreflector comprises a polymer having physical characteristics that are set into effect depending on a voltage applied to said retroreflector.

12. The traffic safety system of claim 8, wherein said polymer is located between two substantially transparent conducting plates, whilst said voltage is applied to said conducting plates.

13. The traffic safety system of claim 1, wherein said retroreflector is substantially rigid.

14. The traffic safety system of claim 1, wherein said retroreflector is flexible.

15. The traffic safety system of claim 1, wherein said electrical drive is powered by at least one of the following means: disposable batteries, rechargeable batteries, solar cells, paper batteries or Piezo-charge generators and dynamo generators.

16. The traffic safety system of claim 1, wherein said electrical drive is energized by radiation striking said retroreflecting system.

17. The traffic safety system of claim 1, wherein said retroreflector comprises a voltage grid configuration.

18. The traffic safety system of claim 1, wherein said retroreflector comprises a voltage grid configuration composed by standard retroreflector and modulatable retroreflector.

19. The traffic safety system of claim 1 further comprising:
a sensor that activates said electrical drive only when the intensity of the daylight is below a certain threshold.

20. The traffic safety system of claim 1 further comprising a sensor system able to detect retroreflected radiation.

21. The traffic safety system of claim 209, wherein said sensor system comprises a warning apparatus to emit a warning signal.

22. The traffic safety system of claim 209, wherein said sensor system comprises a lock-in amplifier.

23. The traffic safety system of claim 209, wherein said sensor system comprises a modulator.

24. The traffic safety system of claim 209, wherein said sensor system comprises at least one of the following radiation sources: an IR radiation source or a Gunn diode.

25. The traffic safety system of claim 209, wherein said sensor system emits a warning signal upon detecting radiation that is retroreflected due to radiation having intensity above a predetermined threshold.

26. The sensor system of claim 209 further comprising: an amplifier operating at a synchronized frequency.

27. The traffic safety system of claim 7 wherein the mechanical modulation means include a motor adapted to vibrating flexible membrane, there by effecting the retroreflecting mode.

28. The traffic safety system of claim 1

29. A method for causing an observer of retroreflected radiation to pay closer attention to retroreflecting object, said method comprising:
switching between reflecting mode and non retroreflecting mode at certain frequency, thereby creating flickering effect.
